(19) United States
(12) Patent Application Publication
(10) Pub. No.: US 2006/0099410 A1
(43) Pub. Date: May 11, 2006

(54) Curtain-coated polyvinyl alcohol oil and grease barrier films

(76) Inventor: Gerald D. Miller, Humble, TX (US)

Correspondence Address: M. Susan Spiering;c/o Celanese Ltd., 400 HWY 77 S / PO BOX 428, BISHOP, TX, 78343, US

(21) Appl. No.: 11/316,188

(22) Filed: Dec. 22, 2005

Related U.S. Application Data
(63) Continuation-in-part of application No. 10/859,023, filed on Jun. 2, 2004.
(60) Provisional application No. 60/497,291, filed on Aug. 22, 2003.

(51) Int. Cl. B32B 27/00

(52) U.S. Cl. 428/341; 428/500; 427/420

(57) ABSTRACT

A method of providing an oil and grease resistant coating to a substrate includes the steps of (i) providing a substrate with a first and second surface to a coating station; (ii) curtain coating at least one surface of the substrate with an aqueous polyvinyl alcohol composition to form a nascent polyvinyl alcohol barrier film thereon; and (iii) drying the nascent polyvinyl alcohol barrier film to form a polyvinyl alcohol oil and grease barrier coating; wherein the polyvinyl alcohol composition as well as the substrate and coating and drying conditions are selected such that the polyvinyl alcohol oil and grease barrier coating is substantially pinhole free, characterized in that the barrier coating exhibits a TAPPI 559 kit test rating of at least 7.

### CLAIM OF PRIORITY

This application is a continuation-in-part of co-pending application U.S. Ser. No. 10/859,023 entitled “Improved PVOH Barrier Performance on Substrates”, (Attorney Docket No. C-7222) filed on Jun. 2, 2004, which was based on Provisional Application Ser. No. 60/497,291, filed on Aug. 22, 2003. The disclosure of U.S. patent application Ser. Nos. 10/859,023 and 60/497,291 are hereby incorporated in their entirety into this application by reference thereto and their priorities are claimed in accordance with 37 CFR §1.78.

### TECHNICAL FIELD

The present invention relates, in part, to a method of manufacturing oil and grease resistant coatings utilized in the packaging industry. There is provided with connection with the present invention a method for curtain coating aqueous polyvinyl alcohol compositions onto substrates to form substantially pinhole free oil and grease barrier coatings. Generally, the oil and grease barrier coatings of the present invention exhibit a TAPPI 559 kit test rating of at least 7, and preferably greater than 10.

### BACKGROUND

Packaging is very important in today's market. Not only should the packaging be aesthetically appealing to the eye, but it should also be functional and efficient. In particular, packaging should be, among other things, oil and grease resistant. This is important to prevent oil and grease from bleeding through the packaging material, causing leakage and staining. Accordingly, packaging materials such as, for example, paper, paperboard, plastic, fiberglass, canvas or cloth/textile substrates, or the like, are often treated with special coatings that provide oil/grease resistance. Such coated packaging materials are collectively referred to as Oil and Grease Resistant (hereinafter abbreviated “OGR”) Papers.

OGR papers are, generally, used for packaging any items that include oil, grease, or other organic solvents. In particular, OGR papers are used in the food industry for producing liners to be applied in packaging items such as pizza boxes, popcorn boxes/bags, microwavable food packaging, butter wraps, bakery items, and fast food wraps (e.g., hamburgers, hot dogs, French fries containers, and so forth). Additional applications of OGR papers may include pet food bags, fireplace starter log wraps, silicone release liners, oil containers, cosmetic packaging, and so forth.

For years, most oil and grease resistant coatings contained chemicals known as fluorocarbons. However, fluorocarbon-based compositions are very expensive for use in OGR papers coatings. More importantly, fluorocarbon-based compositions have recently come under governmental scrutiny due to their unfavorable potential environmental effects. Fluorocarbons are non-biodegradable and possibly toxic. Therefore, there is a need for an alternative non-fluorocarbon coating in the OGR papers industry, which would have similar or superior oil and grease resistance properties in packaging.

One common alternative in the industry is polyethylene oil/grease resistant films. However, polyethylene barriers are not biodegradable and cannot be recycled or repulped. Another alternative is oil/grease resistant films containing polyvinyl alcohol. Coatings containing some polyvinyl alcohol are known in the food container industry. For example, U.S. Pat. No. 4,418,119 to Morrow et al. is directed towards an ovenable board used in packaging of pre-prepared food products such as pizzas and baked goods that is coated with polyvinyl alcohol and silicone to ensure oil resistance and release properties. The board described in the '119 patent is coated with a polyvinyl alcohol layer by means of a #7 rod and then overcoated with a silicone solution containing heptane and toluene with a #5 rod to ensure release of food from the board. U.S. Pat. No. 6,193,831 to Overcash et al. is directed towards sheet materials used in making cooking or baking containers/wrappers. The sheet material described in the '831 patent is coated with a first coating layer composition containing a crosslinkable polymer that imparts water resistance and a polymer that imparts oil/grease resistance, and a second coating layer that imparts release properties. The sheet material in '831 may contain polyvinyl alcohol as either one or both of the polymers used in the first coating layer. See also, U.S. Pat. No. 5,587,204 to Kinsey et al., which is directed towards a multilaminar paperboard with enhanced recyclability. The paperboard described in the '204 patent is coated with a fully hydrolyzed polyvinyl alcohol layer and an adjacent polyethylene layer. The polyvinyl alcohol layer is used as a binder material between the polyethylene coating and the substrate to reduce penetration of polyethylene into the substrate.

Coatings may be applied onto substrates by various methods known in the art such as blades, bars, reverse rolls, curtain coaters, and so forth. Curtain coaters have been used for over thirty years in the photographic industry as described in U.S. Pat. Nos. 3,508,947 and 3,632,374 to Hughes and Greiller, respectively. Curtain coaters are used for paper coatings as well. For example, U.S. patent application Ser. No. 10/257,172 (Publication No. US 2003/0188839) is directed towards the use of a curtain coater to apply a composite of multilayer coatings to paper, where the coating composite may include functional layers to enhance paper properties such as, among others, water resistance, gloss, oil resistance, printability, adhesion, and so forth. The composite coating described in the '172 application may include polyvinyl alcohol among its components. See also, U.S. patent application Ser. No. 10/273,866 (Publication No. US 2003/0194501), which is directed towards a curtain coater used to apply a coating composite, which contains at least two components capable of reacting with each other to achieve improved substrate properties such as printing quality. The process described in the '866 application incorporates polyvinyl alcohol as one of the components in the composite coating.

Despite the plentiful art, there exists a need in the industry for an efficient oil and grease barrier coating that provides a substantially pinhole free coating with enhanced oil and grease resistance, while maintaining ease of application and processsability. The present invention is directed towards such barrier coatings.

### SUMMARY OF THE INVENTION

It has been discovered according to the present invention that superior performance properties can be provided to oil and grease barrier coatings by curtain coating aqueous polyvinyl alcohol (hereinafter abbreviated as “PVOH”) compositions onto substrates.

According to one aspect of the present invention, there is provided a method of producing oil and grease resistant coatings comprising the steps of (a) providing a substrate with a first and second surface to a coating station; (b) curtain coating at least one surface of the substrate with an aqueous polyvinyl alcohol composition to form a nascent polyvinyl alcohol barrier film thereon; and (c) drying the nascent polyvinyl alcohol barrier film to form a polyvinyl alcohol oil and grease barrier coating. The substrate and polyvinyl alcohol composition as well as the coating and drying conditions are selected such that the polyvinyl alcohol oil and grease barrier coating is substantially pinhole free, characterized in that the barrier coating exhibits a TAPPI 559 kit test rating of at least 7. In preferred embodiments the barrier coating exhibits a TAPPI 559 kit test rating of at least 10 and even 12. In some embodiments, the barrier coating also exhibits a vegetable oil crease resistance value of at least about 240 minutes, and even a turpentine crease test value of at least 1800 seconds.

The oil and grease barrier coating may comprise multiple layers of polyvinyl alcohol composition that are applied in a single pass. In a preferred embodiment, the polyvinyl alcohol composition is applied at a coatweight of from about 3 g/m² to about 20 g/m², based upon the surface area of the first surface of the substrate. More preferably, the polyvinyl alcohol composition is applied at a coatweight of from about 5 g/m² to about 15 g/m², based upon the surface area of the first surface of the substrate. The polyvinyl alcohol composition is applied to the first and second surfaces of the substrate at a total coatweight of from about 5 g/m² to about 20 g/m² based upon the surface area of the first and the second surfaces of the substrate in some embodiments.

The polyvinyl alcohol composition may include at least about 5% add-on level of a polyvinyl alcohol polymer by weight of the substrate, and more preferably from about 11% to about 20% add-on level. In still yet other embodiments, the polyvinyl alcohol composition comprises polyvinyl alcohol polymer which includes at least one co-monomer selected from ethylene, methyl acrylate, carboxylic acid, alkyl acid vinyl ester, acryl amide, a sulfonic acid modified comonomer, and mixtures thereof. The aqueous polyvinyl alcohol composition may include from about 7 weight percent to about 20 weight percent polyvinyl alcohol.

The polyvinyl alcohol typically has a degree of hydrolysis of at least about 87.0%, with some preferred hydrolysis levels of from about 91.0% to about 97%, and others of at least about 98.0%. Additionally, the polyvinyl alcohol composition has a preferred characteristic viscosity of from about 3 to about 60 cps, and especially preferred characteristic viscosity of from about 5 to about 10 cps.

The oil and grease barrier coating may further comprise optional additives selected from plasticizers, surfactants, pigments, moisture barrier components and mixtures thereof applied in a single pass. Preferably, the barrier coating contains an organic plasticizer that is selected from polyethylene glycols; polypropylene glycols; aminoalcohols; 1,3-pentanediol; 2,2,4-trimethyl-1,3-pentadiol; glycerin; water; and mixtures thereof.

The substrate in the inventive method may be comprised of at least one layer of a material selected from the group consisting of paper, paperboard, plastic, fiberglass, canvas, and textile materials. Most preferably the substrate is paper or paperboard.

In another aspect of the present invention, there is provided a method of producing an oil and grease resistant paper comprising the steps of (a) providing a paper substrate to a coating station; (b) curtain coating at least one surface of the paper with an aqueous polyvinyl alcohol composition to form a nascent polyvinyl alcohol barrier film thereon; and (c) drying the nascent polyvinyl alcohol barrier film to form a polyvinyl alcohol oil and grease barrier coating. The polyvinyl alcohol composition as well as the substrate and coating and drying conditions are selected such that the polyvinyl alcohol oil and grease barrier coating is substantially pinhole free, characterized in that the barrier coating exhibits a TAPPI 559 kit test rating of at least 7.

In still another aspect of the present invention, there is provided a method of producing an oil and grease resistant container comprising the steps of (a) providing a substrate with a first and a second surface to a coating station; (b) curtain coating at least one surface of the substrate with an aqueous polyvinyl alcohol composition to form a nascent polyvinyl alcohol barrier film thereon; (c) drying the nascent polyvinyl alcohol barrier film to form a polyvinyl alcohol oil and grease barrier coating; and (d) shaping the coated substrate into a container defining an interior thereof such that the polyvinyl alcohol oil and grease barrier coating is between the interior of the container and the substrate. The polyvinyl alcohol composition as well as the substrate and coating and drying conditions are selected such that the polyvinyl alcohol oil and grease barrier coating is substantially pinhole free, characterized in that the barrier coating exhibits a TAPPI 559 kit test rating of at least 7.

In yet another aspect of the present invention, there is provided a coated substrate comprising (a) a substrate having a first and second surface; and (b) an oil and grease barrier coating on the first surface of the substrate comprising a polyvinyl alcohol composition applied at a coatweight of at least about 3 g/m², based upon the surface area of the first surface of the substrate. The polyvinyl alcohol composition, as well as the substrate and coating and drying conditions, are selected such that the polyvinyl alcohol oil and grease barrier coating is substantially pinhole free, characterized in that the barrier coating exhibits a TAPPI 559 kit test rating of at least 7.

The oil and grease barrier coating is prepared from an aqueous composition having a polyvinyl alcohol polymer having hydrolysis degree of from about 87% to about 89% ard characteristic viscosity of from about 5.0 to about 7.0 cps.

There is still further contemplated within the scope of the present invention an oil and grease barrier coating that consists essentially of polyvinyl alcohol.

There is also contemplated within the scope of the present invention an oil and grease barrier coating comprising (a) polyvinyl alcohol; and (b) plasticizer. The polyvinyl alcohol and plasticizer are selected, applied and present in amounts such that the oil and grease barrier coating is substantially pinhole free, exhibits a TAPPI kit test rating of at least 5, and is heat sealable at a temperature of about 175° C. or less; suitably from about 150° C. to about 175° C.

The plasticizer is present in an amount of from about 10% to about 30% by dry weight of the oil and grease barrier coating and is selected from polyethylene glycols; polypropylene glycols; aminoalcohols; 1,3-pentanediol; 2,2,4-trimethyl-1,3-pentadiol; glycerin; water; and mixtures thereof.

The inventive oil and grease barrier coating may further be applied to paper and exhibit at least 30% fiber tear strength when heat sealed at a temperatures of about 175° C. or lower.

Still further features and advantages of the invention are apparent from the following description.

### BRIEF DESCRIPTION OF DRAWINGS

The invention is described in detail below with reference to the various Figures wherein like numerals designate similar parts and wherein:

FIG. 1 is a schematic view showing a curtain coating station; and

FIG. 2 is a graph showing the dependency of glass transition temperature of a barrier coating on relative humidity and plasticizer amount.

### DETAILED DESCRIPTION OF THE INVENTION

The invention is described in detail below for purposes of illustration only. Modifications within the spirit and scope of the invention, set forth in the appended claims, will be readily apparent to one of skill in the art. Unless more specifically defined, terminology and abbreviations have their ordinary meaning; for example, “cps” refers to centipoises, “mils” refer to thousandths of an inch, and so forth.

“Characteristic viscosity” is defined as the viscosity of an aqueous solution having 4% solids at 20° C.

“Coatweight” and “add-on” refer to dried films unless otherwise indicated.

When we refer to an oil and grease barrier coating as “consisting essentially” of polyvinyl alcohol, we refer to barrier coatings without other polymer film layers which are effective as oil and grease barrier films, such as polyethylene films, but do not exclude other additives such as plasticizers, moisture barrier components, pigments and so forth as noted herein. The “consisting essentially” language also specifies that the oil and grease barrier coating is predominantly (more than 50 wt. % on a dry basis) polyvinyl alcohol. More preferably, in some cases, the polyvinyl alcohol oil and grease barrier layer is from about 75 to about 100 weight percent polyvinyl alcohol.

For purposes of this application, the term “continuous” and like terminology, as related to layers or films, refers to a coating or film that is substantially pinhole free. A substantially pinhole free oil and grease barrier coating of the present invention preferably exhibits a TAPPI 559 kit test rating of at least about 7, and more preferably at least about 10. A substantially pinhole free film may exhibit a slightly lower TAPPI 559 kit test rating in some cases. The term “discontinuous” or “noncontinuous” in the same context refers to a layer or film that is applied in discrete areas, and therefore, contains a relatively large number of pinholes. Alternatively, “discontinuous” and “noncontinuous” refer to layers or films that form coatings exhibiting TAPPI 559 kit test ratings below 4.

“Glass transition temperature” (hereinafter abbreviated as “Tg”) is preferably measured by dynamic mechanical analysis (hereinafter abbreviated as DMA). DMA evaluates mechanical properties of elastomers while measuring their amplitude and displacement phase in response to a constant oscillating force. Gradual change in temperature, while maintaining a constant oscillating force, during a DMA experiment can determine the Tg, i.e. the point at which the state of an elastomer changes from glassy to rubbery (or vice versa).

A coating is “heat sealable” at a specified temperature if a coated and heat-sealed Kraft substrate exhibits “fiber tear,” i.e. failure of substrate bonding prior to coating, over at least about 10% of the bonded area when heat sealed to a like substrate with a temperature controlled hand sealer at the specific temperature. Fiber tear is observed when the sample is separated by pulling the two substrates apart.

“Kraft paper” refers to paper made from wood pulp treated with a solution of sodium sulfate, and used chiefly for bags and other packaging products. Kraft paper is a preferred substrate of the invention in many applications, and is a preferred packaging material.

“Percent” refers to weight percent unless otherwise indicated and refers to weight percent without water unless the inclusion of the water weight is expressly indicated, for example, when referring to an aqueous composition.

The terms “PVOH,” “PVOH composition,” “polyvinyl alcohol polymer,” and “PVOH polymer” include polyvinyl alcohol (hereinafter abbreviated as “PVOH”) homopolymers, copolymers incorporating at least one co-monomer, and blends thereof unless otherwise noted. It is understood that the term “copolymer” as used herein is a polymer incorporating at least two monomer units and therefore includes terpolymers and the like.

As is well known in the art, PVOH is made by saponification of polyvinyl acetate homopolymers or copolymers which may include other ethylenically unsaturated co-monomers such as ethylene, methyl acrylate, carboxylic acid, alkyl acid vinyl ester, acryl amide, a sulfonic acid modified comonomer, and mixtures thereof. PVOH resins employed in the present invention are predominately (more than 75 mole %) based on vinyl acetate monomer which is polymerized and subsequently hydrolyzed to polyvinyl alcohol. The degree of hydrolysis refers to the mole % of the resin's vinyl acetate monomer content that has been hydrolyzed.

If used, comonomers may be present from about 0.1 to 25 mole % with vinyl acetate. Other suitable comonomers include glycol comonomers, versatate comonomers, maleic or lactic acid comonomers, itaconic acid comonomers and so forth. Vinyl versatate including alkyl groups (veova) comonomers may likewise be useful. See Finch et al., Ed. Polyvinyl Alcohol Developments (Wiley 1992), pp. 84 and following. The comonomers may be grafted or co-polymerized with vinyl acetate as part of the backbone. Likewise, homopolymers may be blended with copolymers, if so desired.

Methods of producing polyvinyl acetate-polyvinyl alcohol polymers and copolymers are known to those skilled in the art. U.S. Pat. Nos. 1,676,156; 1,971,951; and 2,109,883, as well as various literature references describe these types of polymers and their preparation. Among the literature references are “Vinyl Polymerization”, Vol. 1, Part 1, by Ham, published by Marcel Dekker, Inc., (1967) and “Preparative Methods of Polymer Chemistry”, by Sorenson and Campbell, published by Interscience Publishers, Inc., New York (1961).

“A TAPPI 559 kit test rating” is a measure of the repellency of a coating to oil and grease and is performed in accordance with TAPPI method T-559 pm-96, incorporated herein by reference. In this test, 12 increasingly aggressive oil solutions are prepared according to Table 1:

TABLE 1
Mixtures of Reagents for Preparing Kit Solutions

| | Castor Oil¹ | Toluene | n-Heptane |
|---|---|---|---|
| Kit. No. | [g] | [mL] | [mL] |
| 1 | 969.0 | 0 | 0 |
| 2 | 872.1 | 50 | 50 |
| 3 | 775.2 | 100 | 100 |
| 4 | 678.3 | 150 | 150 |
| 5 | 581.4 | 200 | 200 |
| 6 | 484.5 | 250 | 250 |
| 7 | 387.6 | 300 | 300 |
| 8 | 290.7 | 350 | 350 |
| 9 | 193.8 | 400 | 400 |
| 10 | 96.9 | 450 | 450 |
| 11 | 0 | 500 | 500 |
| 12 | 0 | 450 | 550 |

¹The density of castor oil used in this test is 0.969 g/cm³.

Next, one kit solution drop (see Table 1, typically an intermediate kit number is selected) is released onto the surface of a clean sample of a coated substrate from a height of about 13 mm (0.5 in) and wiped off after exactly 15 seconds. Subsequently, the surface of the sample is immediately examined for any darkening specks. Darkening specks indicate penetration of the kit solution into the sample due to presence of pinholes, therefore denoting failure of the sample to pass the test. The examination of the sample surface must occur immediately, because volatile components of the kit test solution may be lost and the area may regain its original light reflectance value and be scored as “passed”.

If the sample passes the first test, i.e., no darkening specks are observed, the test is repeated in the same manner with a higher numbered kit solution until the highest numbered kit solution that remains on the surface of the sample for 15 seconds without causing failure (penetration through pinholes) is identified. If the sample fails the first test, the test is repeated in the same manner with the next lower numbered kit solution until the highest numbered kit solution that does not cause failure is identified. The highest numbered kit solution that does not cause failure is defined as the TAPPI 559 kit test rating. TAPPI 559 kit test ratings range from 1 to 12, 12 being the highest TAPPI 559 kit test rating, indicating oil/grease resistance to the most aggressive oil mixture. This procedure is preferably repeated 5 times for each sample and the results are averaged. Each test specimen is at least 51 mm×152 mm (2 in×6 in) in size, and it is preconditioned, conditioned and tested in atmosphere in accordance with TAPPI T-402 “Standard Conditioning and Testing Atmospheres for Paper, Board, Pulp Handsheets, and Related Products.” The standard deviation is optionally reported; however, is not necessary for present purposes. Paper is the preferred substrate; however, other substrates are contemplated herein.

“Turpentine Test Value” is a measure of the relative rates at which oils/greases may be expected to penetrate flat/creased papers, and it is performed in accordance with TAPPI method T-454 om-94. The test reagent is prepared by mixing 100 mL of turpentine with 5.0 g of anhydrous calcium chloride and 1.0 g of an oil-soluble red dye. Subsequently, a flat, horizontal coated substrate sample is placed on a paper sheet, and a hollow tube is placed on top of the sample. Next, 5±0.1 g of sand is placed in the tube (the tube facilitates uniform application and area of the sand pile onto the sample; once the sand is placed, the tube is removed by careful vertical lifting). Next, 1.1 mL of the colored turpentine mixture is added to the sand pile (1.1 mL of turpentine is to saturate exactly 5 g of sand) and a timer is started as the last drop of turpentine is deposited into the sand pile.

The timer measures the turpentine test value, which is defined as the elapsed time from addition of the turpentine to the sand to the first sign of staining on the paper sheet below the sample. Any sample that requires over 2 minutes (120 seconds) to stain is covered with a watch glass. The test is repeated for nine more samples (four with the same surface up as with the first substrate, five with the opposite surface), and results are averaged. If staining has not occurred in 30 minutes (1800 seconds), the test is terminated and the result is reported followed by a plus sign (i.e., 1800+). For each sample, 4 inch square test specimen is prepared. The turpentine used in this test is pure gum spirits turpentine with specific gravity of 0.860 to 0.875 at 16° C. (60° F.). The sand used in the test is Ottawa cement testing sand, screened to pass a No. 20 and be retained in a No. 30 sieve. The sample substrate is preconditioned, conditioned and tested in atmosphere in accordance with TAPPI T-402. It should be noted that the conditioning of the sample is important in this test because it has been determined that temperature has a strong influence on the test results.

A similar turpentine test is performed on a creased coated substrate sample which is creased according to TAPPI useful Method T-512 sp-96 and unfolded prior to testing. This test is used to determine a turpentine crease test value, which is reported in seconds. Two diagonal creases on each sample are prepared as follows. Two of the opposite corners of a sample are brought together to induce a fold along a diagonal. The sample is put on a creasing surface, and, while holding the corners, a creasing roller is rolled once along the fold at a rate of 25±12 mm/s (1 in/s) to form a crease. The substrate is then unfolded and lightly refolded along the other diagonal with the reverse side folded in, and again creased with the roller. The roller in this test weighs 20.0±0.4 N (2.04 Kgf or 4.5 lbf), and it has a Shore A Durometer hardness of 75±5. The dimensions of the roller are 95±5 mm (3.75 in) diameter and 45±5 mm (1.75 in) wide. A handle is so attached at the axis of the roller that it can be used without additional pressure being applied by the operator. The creasing surface consists of a flat, rectangular plate with a flatness of 0.13 mm (0.005 in) within 300 mm (12 in) and thickness of approximately 6mm (0.25 in). The width and length of the creasing surface are required to be at least 25 mm (1 in) longer than the specimen size.

“Vegetable Oil Resistance Value” is a measure of the transudation of oily or greasy constituents of products to flexible packages, and it is performed in accordance with a modified version of the TAPPI method T-507 cm-99. This test, as well, is performed on flat and creased coated substrate samples. First, the test reagent is prepared by mixing 100 mL of vegetable oil with 1 mL of oil-soluble red dye. Subsequently, 1.0 mL of the test reagent is applied uniformly to Bach of the smaller blotters so as to substantially saturate them. Next, an assembly of an indicator sheet, an uncreased sample substrate, side to be tested facing up, and a saturated blotter are placed on top of each other, the indicator sheet being on the bottom. The assembly is then placed on a bedplate, and a pressure block is placed on top of it to ensure intimate contact between the components. Immediately, the assembly is placed in an oven at 60±3° C. (140° F.) and a timer is started.

The timer measures the vegetable oil resistance value, which is defined as the elapsed time from placement in the oven to the first sign of staining on the indicator sheet at the bottom of the assembly. The results are averaged and reported in minutes. If staining has not occurred in 4 hours (240 minutes), the test is terminated and the result is reported followed by a plus sign (i.e., 240+). A similar vegetable oil test is performed on a creased coated substrate sample which is creased according to TAPPI useful Method T-512 sp-96, as mentioned above, and unfolded prior to testing. The results on a creased sample are reported in minutes as a vegetable oil crease resistance value.

The pressure block used in the vegetable oil test measures 102±2 mm (4.0 in) square and weighs 408±8 g (0.9 lb). The creasing roller has the same weight and dimension as the roller in the turpentine test. The saturated blotters are of white blotting paper as specified in TAPPI T-205 and cut into 76±2 mm (3 in) squares. The indicator sheet is a densified paper having a weight of 55 g/m² and a TAPPI 559 kit test rating of 3.

The oil and grease barrier coatings of the present invention are produced by curtain coating substrates with aqueous layers of PVOH compositions that upon drying form substantially pinhole free barrier films, which exhibit enhanced oil and grease resistance properties. In particular, the curtain coated oil and grease barrier films of the present invention form oil and grease barrier coatings that exhibit TAPPI 559 kit test ratings of at least 7.

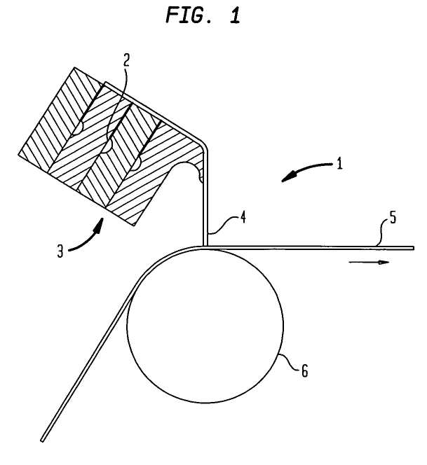

A curtain coater is used to apply single or multiple liquid coating layers in a single pass. The curtain coating process and the operation and use of curtain coaters in general are described in U.S. patent application Ser. No. 10/257,172 (Publication No. US 2003/0188839) and Ser. No. 10/273,866 (Publication No. US 2003/0194501), the entireties of which are incorporated herein by reference. As illustrated in FIG. 1, the curtain coating station 1, consists of a reservoir 3 with tapered sides that narrow to form a slit in the bottom. The coating solution is pumped into the reservoir, which may be a multi-layer reservoir as indicated at 2, and continuously falls by gravity in an unbroken, unsupported liquid sheet, or “curtain,” 4, through the reservoir slit onto a horizontally moving web 5, optionally while it passes over a roll 6, depositing an even layer of coating.

An important aspect of a curtain coater is establishing and maintaining a stable vertical “curtain” with a stable contact line on the moving web. This is achieved by using a curtain coating fluid with an appropriate surface tension and shear thinning behavior. The surface tension facilitates a liquid sheet that would not “break,” while the shear thinning behavior provides for reduced liquid viscosity at the point of its contact with the web.

Curtain coaters may be used to apply single or multiple layers of PVOH compositions to one or two surface(s) of a substrate in single, simultaneous, or multiple passes. It should be noted that the number of layers can be in the range of about 7-20 layers or more. The number of layers is controlled by the equipment used and can be expanded at will. In the present invention, the number of layers is determined by the number necessary to form a continuous PVOH dried film. It should be noted, however, that when multiple layers of a PVOH composition are applied to a surface of a substrate, the oil and grease resistance of the resulting barrier coating is determined by the total dry coatweight of the PVOH film. For example, a single layer of PVOH film at a coatweight of about 10 g/m² on the surface of a substrate may provide the same oil and grease resistance as two layers of PVOH film at coatweight of about 5 g/m² each.

The ability to apply single or multiple liquid layers of coating onto a substrate in a single pass is important, since placing substrates through coating machines more than once is unfavorable due to potential damage to the substrates. The ability to produce a continuous film of PVOH is important as well, because such a film provides for a substantially pinhole free barrier coating with the capability of providing effective oil and grease resistance properties to a substrate.

The oil and grease barrier coating of the present invention comprises an aqueous PVOH composition containing PVOH polymers. In general, any commercially available grade of PVOH may be used in the present invention. Preferably, the PVOH resins of the present invention have a degree of hydrolysis of at least about 75.0 percent, and most preferably the PVOH resins of the present invention have degrees of hydrolysis of greater than about 92.0 percent or even greater than about 98.0 percent. However, it is to be understood that in some embodiments the degree of hydrolysis may range from 50% to 100%. Mixed PVOH grades, using combinations of PVOH polymers varying in molecular weight and polymer hydrolysis level, can also be employed in various embodiments of the processes and products described herein. Exemplary PVOH resins that are commercially available from Celanese, Inc. include the polymers shown below in Table 2:

TABLE 2
Polyvinyl Alcohol Resins

| | | | |
|---|---|---|---|
| Grade | % Hydrolysis, | Viscosity, cps¹ | pH |

Super Hydrolyzed

| | | | |
|---|---|---|---|
| Celvol 125 | 99.3+ | 28-32 | 5.5-7.5 |
| Celvol 165 | 99.3+ | 62-72 | 5.5-7.5 |

Fully Hydrolyzed

| | | | |
|---|---|---|---|
| Celvol 103 | 98.0-98.8 | 3.5-4.5 | 5.0-7.0 |
| Celvol 305 | 98.0-98.8 | 4.5-5.5 | 5.0-7.0 |
| Celvol 107 | 98.0-98.8 | 5.5-6.6 | 5.0-7.0 |
| Celvol 310 | 98.0-98.8 | 9.0-11.0 | 5.0-7.0 |
| Celvol 325 | 98.0-98.8 | 28.0-32.0 | 5.0-7.0 |
| Celvol 250 | 98.0-98.8 | 62.0-72.0 | 5.0-7.0 |

Intermediate Hydrolyzed

| | | | |
|---|---|---|---|
| Celvol 418 | 91.0-93.0 | 14.5-19.5 | 4.5-7.0 |
| Celvol 425 | 95.5-96.5 | 27-31 | 4.5-6.5 |

Partially Hydrolyzed

| | | | |
|---|---|---|---|
| Celvol 502 | 87.0-89.0 | 3.0-3.7 | 4.5-6.5 |
| Celvol 203 | 87.0-89.0 | 3.5-4.5 | 4.5-6.5 |
| Celvol 205 | 87.0-89.0 | 5.2-6.2 | 4.5-6.5 |
| Celvol 513 | 87.0-89.0 | 13-15 | 4.5-6.5 |
| Celvol 523 | 87.0-89.0 | 23-27 | 4.5-6.5 |
| Celvol 540 | 87.0-89.0 | 45-55 | 4.5-6.5 |

¹4% aqueous solution, 20° C.

Additionally, the PVOH that is used in the present invention generally has an average molecular weight ranging from about 10,000 to about 200,000. Preferably, the PVOH has an average molecular weight of from about 20,000 to about 130,000. Most preferably, the PVOH has an average molecular weight of from about 30,000 to 70,000. The average molecular weight of the PVOH is roughly proportional to its characteristic viscosity. Accordingly, the PVOH in the present invention has a characteristic viscosity of from about 1 cps to about 50 cps, and more preferably from about 3.0 to about 35.0 cps. In the most preferred embodiment, the PVOH of the present invention has a characteristic viscosity of from about 5.0 cps to about 7.0 cps.

In one embodiment of the present invention, the aqueous PVOH may comprise PVOH solutions with PVOH polymer solids content of from about 1% to about 30%. In another embodiment, the solutions may have PVOH polymer solids content of from about 5% to about 25%. In still another embodiment, the solutions may have PVOH polymer solids content of from about 7% to about 15%.

The PVOH composition of the present invention is curtain coated onto a substrate at a concentration or add-on level sufficient to provide a continuous nascent film. It should be understood, however, that the requisite concentration or add-on level of the PVOH is dependent on the nature of the substrate selected for coating. For example, the necessary add-on level of a relatively thick substrate may be considerably lower than the necessary add-on level for a thinner, or less dense, substrate. Generally, in accordance with the inventive barrier coatings of the present invention, continuous nascent PVOH films are achieved when a PVOH composition is curtain coated onto at least one surface of a substrate at a coatweight of at least about 3 g/m², based upon the coated surface area of the substrate. More preferably, the PVOH composition should be curtain coated onto the substrate surface at coatweight of from about 5 g/m² to about 20 g/m² based upon the coated surface area of the substrate. Most preferably, the PVOH composition should be curtain coated onto the substrate surface at coatweight of from about 10 g/m² to about 15 g/m² based upon the coated surface area of the substrate.

Alternatively, it is generally found that substantially pinhole free oil and grease barrier coatings may be achieved by curtain coating a PVOH composition onto a substrate at an add-on level of at least 5% by weight of the substrate. In another embodiment, the add-on level of the PVOH is from about 10% to about 20%. In still another embodiment, the PVOH add-on level is from about 11% to about 15%.

In accordance with the inventive barrier coatings of the present invention, the PVOH compositions curtain coated onto substrates to form continuous nascent films are subsequently dried to form substantially uniform and pinhole free oil and grease barrier coatings. More preferably, the barrier films are of substantially uniform thickness. In particular, the oil and grease barrier coatings of the present invention are substantially pinhole free in that they exhibit TAPPI 559 kit test rating of at least about 7. More preferably, the barrier coatings exhibit TAPPI 559 kit test rating of from about 8 to about 10. Most preferably, the barrier coatings exhibit TAPPI 559 kit test rating of from about 10 to about 12. Additionally, the oil and grease barrier coatings of the present invention exhibit vegetable oil crease test resistance value of at least 240 minutes and a turpentine crease test value of at least 1800 seconds.

In another preferred embodiment of the present invention, the oil and grease barrier coating contains additional one or more additives to enhance its performance. It should be noted that the additives may be mixed with the PVOH composition or added as a separate coating layer. When the additives are mixed with the PVOH composition, they increase the solids content of the PVOH composition of up to about 30% in addition to the solids content provided by the PVOH polymers. Preferred additives in the inventive oil and grease barrier coatings of the present invention include plasticizers, crosslinkers, surfactants, pigments, starch, lattices, and the like. Non-formaldehyde crosslinkers such as glyoxal resins are preferred, i.e. Curesan^{r} 199 or 200 available from BASF.

Addition of plasticizers into the oil and grease barrier coatings of the present invention is especially advantageous, especially for heat sealing, as is shown below. Organic plasticizers in the present invention are polyethylene glycols, polypropylene glycols, aminoalcohols, 1,3-Pentanediol, 2,2,4-Trimethyl-1,3-pentadiol, glycerin, and combinations thereof. A most preferred plasticizer is glycerin. The plasticizers should be used in the present invention in amounts of from about 5% to about 35% by dry weight of the oil and grease barrier coating. Water also acts as a plasticizer and may be used alone or with other plasticizers.

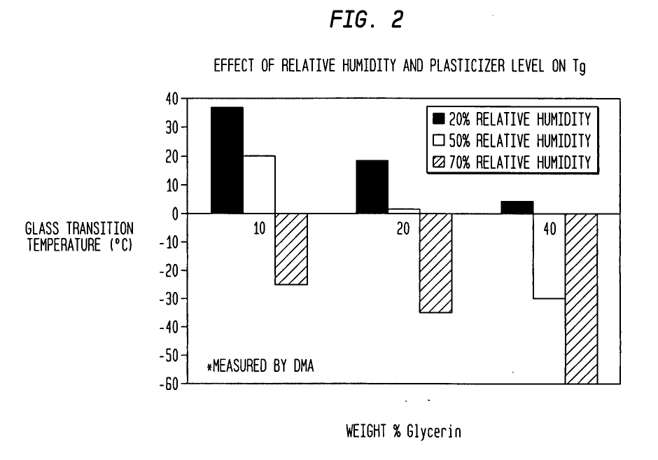

Relatively high humidity may be used in order to reduce the amount of organic plasticizer incorporated into the barrier coating to achieve improved flexibility and lower Tg, as shown in FIG. 2. In a preferred embodiment of the present invention, the Tg value of the barrier coating should be from about 20° C. to about −30° C. at 50% relative humidity. Under controlled relative high humidity conditions, the present invention provides for heat sealable barrier coatings in that they exhibit at least 10% fiber tear when heat sealed at about 150° C. More preferably, a heat sealable barrier of the present invention exhibits from about 10% to about 30% fiber tear when heat sealed at about 160° C., or most preferably, at least 50% fiber tear when heat sealed at about 177° C.

In another embodiment of the present invention the PVOH oil and grease barrier coating exhibits additional functional characteristics such as moisture vapor transmission improvement, release properties enhancement, water resistance, and so forth. Functional characteristics may be advantageously achieved by adding into the PVOH composition functional polymers such as Polyvinylidene Chloride (“PVDC”), silicone, and the like, or applying a separate layer with such additives.

The substrate of the present invention may comprise any packaging material used in the art. In particular, suitable substrates in the present invention may be, for example, paper, paperboard, plastic, fiberglass, canvas or cloth/textile substrates, or the like. Preferred substrates are paperboard and paper such as Kraft paper. A substrate in accordance with the present invention is perhaps most preferably provided to a coating station as a continuous horizontal moving web, while an aqueous PVOH composition is released from a curtain coater, located above the horizontal web, in a stable vertical curtain onto the moving web to form a nascent PVOH barrier film. The PVOH nascent barrier film is then dried to form a substantially pinhole free PVOH oil and grease resistant barrier coating. An oil and grease resistant substrate provided in accordance with the present invention may be further formed into an oil and grease resistant container having the oil and grease barrier between its interior and the substrate.

### EXAMPLES 1-37

PVOH oil and grease barrier coating composition were prepared in accordance with the present invention using PVOH polymer products available from Celanese Chemicals under the designations Celvol® 107, Celvol® 125, and Celvol® 205 described in Table 2 above. These PVOH polymers are hompolymer grades and aqueous solution that are prepared having PVOH solids content of 7% (Celvol® 125), solids content of 15% (Celvol® 107), and solids content of 13% (Celvol® 205).

In the prepared coating compositions, the PVOH polymers were the only dissolved solids with the exception of a surfactant, included to assist in maintaining a stable curtain, and a plasticizer in some of the Celvol® 107 formulations (see Table 3) for improved flexibility of the PVOH film. The surfactant used was a liquid commercially available from Air Products & Chemicals under the designation Surfynol SE-F. The surfactant was incorporated at a concentration of 0.075%-0.15% wet/wet basis. The plasticizer was Glycerine, commercially available from All Chem Industries, added to the PVOH solution at 10% wet parts based on dry parts Celvol® 107.

The coating composition were curtain coated in one or two layers onto the surface of densified paper substrates having a weight of 55 g/m² with a TAPPI 559 kit test rating of at least as seen in Table 3. Following application of the PVOH compositions, the substrates were dried at multiple stations and at the temperatures indicated in Table 3. Once the substrates were dried, they were subjected to oil and grease resistance testing.

Oil and grease resistance should be tested in accordance with more than one test method to facilitate detection of potential failure mechanisms. For the purpose of the present application, the barrier coatings of the present invention were subjected to three tests, consequently obtaining a TAPPI 559 kit test rating, a turpentine test value (flat and creased), and a vegetable oil resistance value (flat and creased).

Additional testing methods that may be used to determine the oil and grease resistant properties of substrate coatings are TAPPI T-508 cm-99 Grease Resistance of Flexible Packaging Materials, TAPPI T-559 pm-96 Grease Resistance Test for Paper and Paperboard, Oil Penetration Time, and TAPPI T-462 om-93 Castor Oil Penetration Test for Paper.

The results of the tests are reported in Table 3 below.

TABLE 3

| | | | | PVOH | Line | | | | | | | | |
|---|---|---|---|---|---|---|---|---|---|---|---|---|---|
| | Layer1 | Layer2 | PVOH | (% | Speed | Drier Section ° C. | | | | | | | |
| EX | Celvol ® | Celvol ® | (g/m²) | Add-on) | m/min | 1Top | 1Bot | 2Top | 2Bot | 3Top | 3Bot | 4Top | Bot |
| 1 | 107 | N/A | 7.0 | 11.3 | 150 | 170 | 170 | 190 | 190 | 220 | 220 | 220 | 220 |
| 2 | 107 | N/A | 5.0 | 8.3 | 200 | 170 | 170 | 190 | 190 | 220 | 220 | 220 | 220 |
| 3 | 107 | N/A | 3.0 | 5.1 | 300 | 170 | 170 | 190 | 190 | 220 | 220 | 220 | 220 |
| 4 | 107 | N/A | 7.0 | 11.3 | 150 | 170 | 170 | 200 | 200 | 230 | 230 | 230 | 230 |
| 5 | 107 | N/A | 10.0 | 15.4 | 120 | 170 | 170 | 200 | 200 | 230 | 230 | 230 | 230 |
| 6 | 107/Plas | 107 | 1.75/5.25 | 11.3 | 150 | 170 | 170 | 200 | 200 | 230 | 230 | 230 | 230 |
| 7 | 107/Plas | 107 | 3.5/3.5 | 11.3 | 150 | 170 | 170 | 200 | 200 | 230 | 230 | 230 | 230 |
| 8 | 107/Plas | 107 | 5.25/1.75 | 11.3 | 150 | 170 | 170 | 200 | 200 | 230 | 230 | 230 | 230 |
| 9 | 107/Plas | 107 | 2.5/7.5 | 15.4 | 120 | 170 | 170 | 200 | 200 | 230 | 230 | 230 | 230 |
| 10 | 107/Plas | 107 | 5.0/5.0 | 15.4 | 120 | 170 | 170 | 200 | 200 | 230 | 230 | 230 | 230 |
| 11 | 107/Plas | 107 | 7.5/2.5 | 15.4 | 120 | 170 | 170 | 200 | 200 | 230 | 230 | 230 | 230 |
| 12 | 107/Plas | 107 | [symbol] .75/11.25 | 21.4 | 80 | 170 | 170 | 200 | 200 | 230 | 230 | 230 | 230 |
| 13 | 107/Plas | 107 | 12.0/0 | 17.9 | 100 | 170 | 170 | 210 | 210 | 240 | 240 | 240 | 240 |
| 14 | 107/Plas | 107 | 6.0/6.0 | 17.9 | 90 | 170 | 170 | 210 | 210 | 240 | 240 | 240 | 240 |
| 15 | 107/Plas | 107 | 0/12.0 | 17.9 | 85 | 170 | 170 | 210 | 210 | 240 | 240 | 240 | 240 |
| 16 | 107/Plas | 107 | 0/11.9 | 17.8 | 93 | 170 | 170 | 200 | 200 | 230 | 230 | 230 | 230 |
| 17 | 107/Plas | 107 | 12.0/0 | 17.9 | 100 | 170 | 170 | 200 | 200 | 230 | 230 | 230 | 230 |
| 18 | 107/Plas | 107 | 6.0/6.0 | 17.9 | 90 | 170 | 170 | 200 | 200 | 230 | 230 | 230 | 230 |
| 19 | 107/Plas | 107 | 6.0/6.0 | 17.9 | 95 | 170 | 170 | 200 | 200 | 230 | 230 | 230 | 230 |
| 20 | 205 | N/A | 7.0 | 11.3 | 160 | 170 | 170 | 200 | 200 | 230 | 230 | 230 | 230 |
| 21 | 205 | N/A | 7.0 | 11.3 | 170 | 170 | 170 | 200 | 200 | 230 | 230 | 230 | 230 |
| 22 | 205 | N/A | 10.0 | 15.4 | 170 | 170 | 170 | 200 | 200 | 230 | 230 | 230 | 230 |
| 23 | 205 | N/A | 12.0 | 17.9 | 100 | 170 | 170 | 200 | 200 | 230 | 230 | 230 | 230 |
| 24 | 205 | N/A | 14.0 | 20.3 | 85 | 170 | 170 | 200 | 200 | 230 | 230 | 230 | 230 |
| 25 | 205 | N/A | 14.0 | 20.3 | 90 | 170 | 170 | 200 | 200 | 230 | 230 | 230 | 230 |
| 26 | 125 | N/A | 6.0 | 9.8 | 9.5 | 170 | 170 | 200 | 200 | 230 | 230 | 230 | 230 |
| 27 | 125 | N/A | 60 | 98 | 100 | 170 | 170 | 200 | 200 | 230 | 230 | 230 | 230 |
| 28 | 125 | N/A | 9.0 | 14.1 | 70 | 170 | 170 | 200 | 200 | 230 | 230 | 230 | 230 |
| 29 | 125 | N/A | 9.0 | 14.1 | | 170 | 170 | 200 | 200 | 230 | 230 | 230 | 230 |
| 30 | 125 | N/A | 10.0 | 15.4 | 60 | 170 | 170 | 200 | 200 | 230 | 230 | 230 | 230 |
| 31 | 125 | N/A | 10.0 | 15.4 | 55 | 170 | 170 | 200 | 200 | 230 | 230 | 230 | 230 |
| 32 | 125 | N/A | 12.0 | 17.9 | 50 | 170 | 170 | 200 | 200 | 230 | 230 | 230 | 230 |
| 33 | 205 | 125 | 5.25/1.75 | 11.3 | 130 | 170 | 170 | 200 | 200 | 230 | 230 | 230 | 230 |
| 34 | 205 | 125 | 5.25/1.75 | 11.3 | 140 | 170 | 170 | 200 | 200 | 230 | 230 | 230 | 230 |
| 35 | 205 | 125 | 7.5/2.5 | 15.4 | 90 | 170 | 170 | 200 | 200 | 230 | 230 | 230 | 230 |
| 36 | 205 | 125 | 7.5/2.5 | 15.4 | 100 | 170 | 170 | 200 | 200 | 230 | 230 | 230 | 230 |
| 37 | 205 | 125 | 9.0/3.0 | 17.9 | 80 | 170 | 170 | 200 | 200 | 230 | 230 | 230 | 230 |

| | | | | | | Vegetable Oil | |
|---|---|---|---|---|---|---|---|
| | | | | | | @ 60° C. | |
| | | | TAPPI | | 3M | w/press. (T507) | |
| | | % | Turpentine | | Kit | Flat | Crease |
| EX | ° C.¹ | Surfynol | Flat | Crease | Flat | (min) | (min) |
| 1 | 96 | 0.15 | 1800+ | 100 | 11 | | |
| 2 | 100 | 0.15 | | | 2 | | |
| 3 | 113 | 0.15 | | | 1 | | |
| 4 | 153 | 0.15 | | | 7 | | |
| 5 | 112 | 0.15 | 1800+ | 300 | 12 | | |
| 6 | 113 | 0.15 | | | 7 | | |
| 7 | 116 | 0.15 | | | 7 | | |
| 8 | 126 | 0.15 | | | 8 | | |
| 9 | 82 | 0.15 | 1800+ | 40 | 12 | | |
| 10 | 87 | 0.15 | 1800+ | 1800+ | 12 | 60 | Not |
| | | | | | | | tested |
| 11 | 95 | 0.15 | 1800+ | 630 | 12 | | |
| 12 | 85 | 0.15 | | No | | | |
| | | | | Sample | | | |
| | | | | (poor | | | |
| | | | | drying) | | | |
| 13 | 131 | 0.15 | 1800+ | 300 | 12 | | |
| 14 | 129 | 0.15 | | | 12 | | |
| 15 | 134 | 0.15 | 1800+ | 90 | 11 | | |
| 16 | 90 | 0.15 | 1800+ | 195 | 10 | | |
| 17 | 114 | 0.15 | 1800+ | 1035 | 12 | | |
| 18 | | 0.15 | 1800+ | 95 | 10 | | |
| 19 | 97 | 0.15 | 1800+ | 765 | 12 | | |
| 20 | 133 | 0.075 | 1800+ | 870 | 12 | | |
| 21 | 115 | 0.075 | 1800+ | 545 | 12 | | |
| 22 | 114 | 0.075 | 1800+ | 1095 | 12 | | |
| 23 | 112 | 0.075 | 1800+ | 1800+ | 12 | 180 | Not |
| | | | | | | | tested |
| 24 | 116 | 0.075 | 1800+ | 1800+ | 12 | 180 | Not |
| | | | | | | | tested |
| 25 | 99 | 0.075 | 1800+ | 1800+ | 12 | 240+ | 120 |
| 26 | 89 | 0.15 | 1800+ | no test | 8 | | |
| | | | | (pin | | | |
| | | | | holes) | | | |
| 27 | 110 | 0.15 | 1800+ | no test | 6 | | |
| | | | | (pin | | | |
| | | | | holes) | | | |
| 28 | 107 | 0.15 | 1800+ | 1050 | 11 | | |
| 29 | 83 | 0.15 | 1800+ | 1260 | 12 | | |
| 30 | 81 | 0.15 | 1800+ | 1800+ | 12 | 240+ | 240+ |
| 31 | 118 | 0.15 | 1800+ | 1800+ | 12 | 60 | Not |
| | | | | | | | Tested |
| 32 | 83 | 0.15 | 1800+ | no test | 9 | | |
| | | | | (surface | | | |
| | | | | craters) | | | |
| 33 | 129 | 0.075-0.15 | 1800+ | 1800+ | 12 | 240+ | 240+ |
| 34 | 100 | 0.075-0.15 | 1800+ | 1800+ | 12 | 240+ | 120 |
| 35 | 130 | 0.075-0.15 | 1800+ | 1020 | 12 | | |
| 36 | 94 | 0.075-0.15 | 1800+ | 1800+ | 12 | 240+ | 240+ |
| 37 | 101 | 0.075-0.15 | 1800+ | 1800+ | 12 | 240+ | 60 |

¹Substrate temperature at conclusion of drying process.

By reviewing the data reported in Table 3, it is seen that 34 out of the 37 oil and grease barrier coatings tested were substantially pinhole free in that they exhibited a TAPPI 559 kit test rating of at least 7. It should also be noted that 21 out of the 37 barrier coatings tested exhibited TAPPI 559 kit test rating of 12, which indicated repellency of the most aggressive oil mixtures. Preferred oil and grease barrier coatings tested comprised PVOH composition at a dry coatweight of at least about 6 g/m², or alternatively, at least 9% PVOH add-on level. Additionally, the data of Table 3 also confirms that especially superior oil and grease barrier coating performance may be obtained with PVOH dry coatweights of from about 10 g/m² to about 20 g/m².

The data of Table 3 also reveals that more consistent barrier performance was achieved with oil and grease barrier coatings based upon PVOH polymers having the characteristics of the Celvol® 205 PVOH, i.e., hydrolysis degree of 87%-89% and characteristic viscosity of 5.2-6.2 cps. For example, 9 of the 10 best performing coatings were derived from Celvol® 205, see composition nos. 23-25, 30-31, 33-34, and 36-37.

It is still further observed that when two layers of different PVOH solutions were applied to a substrate surface and one of the layers was based upon Celvol® 205, better performance was achieved when Celvol® 205 was used as the lower layer. This is thought to result from Celvol® 205 forming a relatively flexible coating and because Celvol® 205 coatings are somewhat water sensitive. Therefore, in order to take advantage of the relative flexibility of the Celvol® 205 coating while minimizing the affects of water sensitivity, better performance was attained by placing the Celvol® 205 coating beneath a protective coating of another PVOH coating. However, of course, it is within the contemplation of this disclosure that a Celvol® 205 based coating may be a surface coating or may be applied in multiple coatings on a single substrate.

### EXAMPLE 38

A sulfonate modified PVOH (2-acrylamido-2-methyl-1-propane sulfonc acid (AMPS) modified) composition according to the present invention was prepared and curtain coated onto a glass plate, producing a barrier film having a thickness of approximately 1 mil. The film was dried into oil and grease barrier coating at ambient temperature for about 24 hours. A like oil and grease barrier coating was prepared without AMPS. Both coatings were subjected to kit and turpentine tests and passed. It was observed, however, that the AMPS modified barrier coating showed softer and more flexible properties.

### EXAMPLES 39-41

PVOH compositions were prepared in accordance with the present invention using PVOH homopolymer and Glycerin. Three different compositions were prepared according to Table 4:

TABLE 4
PVOH compositions containing a plasticizer

| | PVOH | Glycerin |
|---|---|---|
| Formulation 1 | 90 | 10 |
| Formulation 2 | 80 | 20 |
| Formulation 3 | 70 | 30 |

The compositions were prepared as aqueous compositions with solids content of 12%. The resulting compositions were coated onto sample paper substrates with Gurley porosity of 19423 sec/100 cc having a TAPPI 559 kit test rating of 3. The samples were heat sealed, and subsequently, tested for seal strength and fiber tear as defined above. The results of the test are reported in Table 5:

TABLE 5
Heat Sealing Data

| | | 90/10 PVOH/ | | 80/20 PVOH/ | | 70/30 PVOH/ | |
|---|---|---|---|---|---|---|---|
| Heat | Heat | Glycerin | | Glycerin | | Glycerin | |
| Sealing | Sealing | | % fiber | | % fiber | | % fiber |
| Temp° F. | Temp° C. | Seal | tear | Seal | tear | Seal | tear |
| 390 | 199 | good | 100 | good | 100 | good | 100 |
| 350 | 177 | good | 20 | good | 50 | good | 70 |
| 320 | 160 | none | 0 | good | 10 | good | 30 |
| 300 | 149 | none | 0 | slight | 0 | good | 10 |
| 290 | 143 | none | 0 | slight | 0 | good | 10 |
| 270 | 132 | none | 0 | slight | 0 | good | 10 |
| 250 | 121 | none | 0 | slight | 0 | good | 0 |
| 230 | 110 | none | 0 | none | 0 | slight | 0 |
| 210 | 99 | none | 0 | none | 0 | none | 0 |

It is seen from Table 5 that heat sealing was dramatically improved by adding plasticizer, especially at lower temperatures.

All patents and publications referred to herein are hereby incorporated by reference in their entireties.

While the invention has been described in connection with numerous examples, modifications to those examples within the spirit and scope of the invention will be readily apparent to those of skill in the art. In view of the foregoing discussion, relevant knowledge in the art and references including co-pending applications discussed above, the relevant disclosures of which are all incorporated herein by reference, further description is deemed unnecessary.

What is claimed is:

1. A method of providing an oil and grease resistant coating to a substrate comprising:
(i) providing a substrate with a first and second surface to a coating station;
(ii) curtain coating at least one surface of the substrate with an aqueous polyvinyl alcohol composition to form a nascent polyvinyl alcohol barrier film thereon; and
(iii) drying the nascent polyvinyl alcohol barrier film to form a polyvinyl alcohol oil and grease barrier coating;
wherein the substrate and polyvinyl alcohol composition as well as the coating and drying conditions are selected such that the polyvinyl alcohol oil and grease barrier coating is substantially pinhole free, characterized in that the barrier coating exhibits a TAPPI 559 kit test rating of at least 7.

2. The method according to claim 1, wherein the barrier coating exhibits a TAPPI 559 kit test rating of at least 10.

3. The method according to claim 1, wherein the barrier coating exhibits a TAPPI 559 kit test rating of at least 12.

4. The method according to claim 1, wherein the barrier film comprises multiple layers of polyvinyl alcohol applied in a single pass.

5. The method according to claim 1, wherein the polyvinyl alcohol composition is applied at a coatweight of from about 3 g/m2 to about 20 g/m2, based upon the surface area of the first surface of the substrate.

6. The method according to claim 1, wherein polyvinyl alcohol composition is applied at a coatweight of from about 5 g/m2 to about 15 g/m2, based upon the surface area of the first surface of the substrate.

7. The method according to claim 1, wherein the polyvinyl alcohol composition comprises polyvinyl alcohol polymer having a degree of hydrolysis of at least about 87.0%.

8. The method according to claim 1, wherein the polyvinyl alcohol composition comprises polyvinyl alcohol polymer having a degree of hydrolysis of from about 91.0% to about 97%.

9. The method according to claim 1, wherein the polyvinyl alcohol composition comprises polyvinyl alcohol polymer having a degree of hydrolysis of more than about 98.0%.

10. The method according to claim 1, wherein the polyvinyl alcohol composition comprises polyvinyl alcohol polymer having characteristic viscosity of from about 3 to about 60 cps.

11. The method according to claim 1, wherein the polyvinyl alcohol composition comprises polyvinyl alcohol polymer having characteristic viscosity of from about 5 to about 10 cps.

12. The method according to claim 1, wherein the oil and grease barrier coating further comprises one or more additives selected from plasticizers, surfactants, pigments, crosslinkers, moisture barrier components and mixtures thereof applied in a single pass.

13. The method according to claim 1, wherein the oil and grease barrier coating includes a plasticizer.

14. The method according to claim 13, wherein the oil and grease barrier coating comprises a plasticizer selected from polyethylene glycols; polypropylene glycols; aminoalcohols; 1,3-pentanediol; 2,2,4-trimethyl-1,3-pentadiol; glycerin; water; and mixtures thereof.

15. The method according to claim 1, wherein the polyvinyl alcohol composition comprises polyvinyl alcohol polymer which includes at least one co-monomer selected from ethylene, methyl acrylate, carboxylic acid, alkyl acid vinyl ester, acryl amide, a sulfonic acid modified comonomer, and mixtures thereof.

16. The method according to claim 1, wherein the substrate is comprised of at least one layer of a material selected from the group consisting of paper, paperboard, plastic, fiberglass, canvas, and textile materials.

17. The method according to claim 16, wherein the substrate is comprised of a material selected from paper and paperboard.

18. The method according to claim 1, wherein the oil and grease barrier coating exhibits a vegetable oil crease resistance value of at least about 240 minutes.

19. The method according to claim 1, wherein the oil and grease barrier coating exhibits a turpentine crease test value of at least 1800 seconds.

20. The method according to claim 1, wherein the polyvinyl alcohol composition includes from at least 5% add-on level of a polyvinyl alcohol polymer by weight of the substrate.

21. The coated substrate of claim 20, wherein the polyvinyl alcohol composition includes from about 11% to about 20% add-on level of a polyvinyl alcohol polymer by weight of the substrate.

22. The method according to claim 1, wherein the polyvinyl alcohol composition is applied to the first and second surfaces of the substrate at a total coatweight of from about 5 g/m2 to about 20 g/m2 based upon the surface area of the first and the second surfaces of the substrate.

23. The method according to claim 1, wherein the aqueous polyvinyl alcohol composition includes from about 7 weight percent to about 20 weight percent polyvinyl alcohol.

24. A method of providing an oil and grease resistant paper comprising:
(i) providing a paper substrate to a coating station;
(ii) curtain coating at least one surface of the paper with an aqueous polyvinyl alcohol composition to form a nascent polyvinyl alcohol barrier film thereon; and
(iii) drying the nascent polyvinyl alcohol barrier film to form a polyvinyl alcohol oil and grease barrier coating;
wherein the polyvinyl alcohol composition as well as the substrate and coating and drying conditions are selected such that the polyvinyl alcohol oil and grease barrier coating is substantially pinhole free, characterized in that the barrier coating exhibits a TAPPI 559 kit test rating of at least 7.

25. A method of producing an oil and grease resistant container comprising:
(i) providing a substrate with a first and a second surface to a coating station;
(ii) curtain coating at least one surface of the substrate with an aqueous polyvinyl alcohol composition to form a nascent polyvinyl alcohol barrier film thereon;
(iii) drying the nascent polyvinyl alcohol barrier film to form a polyvinyl alcohol oil and grease barrier coating; and
(iv) shaping the coated substrate into a container defining an interior thereof such that the polyvinyl alcohol oil and grease barrier coating is between the interior of the container and the substrate;
wherein the polyvinyl alcohol composition as well as the substrate and coating and drying conditions are selected such that the polyvinyl alcohol oil and grease barrier coating is substantially pinhole free, characterized in that the barrier coating exhibits a TAPPI 559 kit test rating of at least 7.

26. A coated substrate comprising:
(i) a substrate having a first and second surface; and
(ii) an oil and grease barrier coating on the first surface of the substrate comprising a polyvinyl alcohol composition applied at a coatweight of at least about 3 g/m2, based upon the surface area of the first surface of the substrate;
wherein the polyvinyl alcohol composition, as well as the substrate and coating and drying conditions, are selected such that the polyvinyl alcohol oil and grease barrier coating is substantially pinhole free, characterized in that the barrier coating exhibits a TAPPI 559 kit test rating of at least 7.

27. The coated substrate according to claim 26, wherein the barrier coating exhibits a TAPPI 559 kit test rating of at least 12.

28. The coated substrate according to claim 26, wherein the oil and grease barrier coating comprises a plasticizer.

29. The coated substrate according to claim 26, wherein the oil and grease barrier coating is prepared from an aqueous composition having a polyvinyl alcohol polymer having hydrolysis degree of from about 87% to about 89% and characteristic viscosity of from about 5.0 to about 7.0 cps.

30. The coated substrate according to claim 26, wherein the oil and grease barrier coating consists essentially of polyvinyl alcohol.

31. An oil and grease barrier coating comprising:
(i) polyvinyl alcohol; and
(ii) plasticizer;
wherein the polyvinyl alcohol and plasticizer are selected, applied and present in amounts such that the oil and grease barrier coating is substantially pinhole free, exhibits a TAPPI kit test rating of at least 5, and is heat sealable at a temperature of about 175° C. or less.

32. The oil and grease barrier coating of claim 31, wherein the plasticizer is present in an amount of from about 10% to about 30% by dry weight of the oil and grease barrier coating.

33. The oil and grease barrier coating of claim 31, wherein the plasticizer comprises an organic plasticizer.

34. The oil and grease barrier coating of claim 31, wherein the plasticizer is selected from polyethylene glycols; polypropylene glycols; aminoalcohols; 1,3-pentanediol; 2,2,4-trimethyl-1,3-pentadiol; glycerin; water; and mixtures thereof.

35. The oil and grease barrier coating of claim 31, wherein the oil and grease barrier coating is applied to paper and exhibits at least 30% fiber tear strength when heat sealed at a temperatures of about 175° C. or less.
